(19) United States
(12) Patent Application Publication
(10) Pub. No.: US 2008/0071881 A1
(43) Pub. Date: Mar. 20, 2008

(54) Advertising on Idle Web Browser Windows

(76) Inventors: Curtis Duane Kronlund, Cottage Grove, MN (US); Scott Alan Moore, Rochester, MN (US); Gregory Allan Olson, Rochester, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/532,120

(22) Filed: Sep. 15, 2006

(51) Int. Cl. G07G 1/14; G06F 15/16

(52) U.S. Cl. 709/217; 705/14; 709/246

(57) ABSTRACT

Methods, computer program products and systems for displaying an advertising image in a Web browser window when the window becomes deactivated or idle for a period of time. The image may replace the Web content previously loaded and displayed in the Web browser window. However, it is desirable for the Web content to remain loaded in memory so that the Web content may be quickly displayed after reactivating the window or detecting user interaction with the window. However, the advertisement preferably remains for a brief delay period after either reactivation or detection of user interaction in order to enhance advertising effectiveness and provide the user with a brief opportunity to read the advertisement, click on a hyperlink for more information, or hold the image for further viewing. After the delay period, the Web content preferably will automatically return to be displayed in the client area of the Web browser window.

### BACKGROUND OF THE INVENTION

1. Field of the Invention

This invention relates generally to presenting advertisements to a web browser accessing one or more websites over a network.

2. Description of the Related Art

Computer on-line services are provided by a wide variety of different companies. In general, most computer on-line services are accessed via the Internet. The Internet is a global network of computers. The structure of the Internet is a network backbone with networks branching from the backbone. These branches, in turn, have networks branching from them, and so on. Routers move information packets from network to network, until the information packets reach their destination.

One popular part of the Internet is the World Wide Web, often referred to simply as the Web. The Web contains computers that display graphical and textual information. A computer that provides information on the Web is typically called a Web server and the information provided is in the form of a “website.” A website is defined by an Internet address which has an associated electronic page, often called a “home page.” Generally, a home page is an electronic document that organizes the presentation of text, graphical images, audio and video into a desired display. These websites are operated by a wide variety of entities that are typically called “content providers.”

A user may access the Internet using a personal computer (PC) equipped with a conventional modem or router. Special interface software is installed within the PC so that when the user wishes to access the Internet, a network interface is automatically instructed to communicate with an Internet Service Provider (ISP). The user can then access information at any address accessible over the Internet through the ISP. Two well-known software interfaces, for example, are the Netscape Navigator developed by Netscape, Inc. and the Microsoft Internet Explorer developed by Microsoft Corporation.

Information exchanged over the Web is typically encoded in HyperText Mark-up Language (HTML) format. The HTML format is a scripting language that is used to generate the home pages for different content providers. In this setting, a content provider is an individual or company that places information (content) on the Web so that it can be accessed by others. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document and causes the document to be formatted in the specified manner.

An HTML document can also include hyper-links that allow a user to move from one document to another document on the Web. A hyper-link is an underlined or otherwise emphasized portion of text which, when selected using an input device, such as a mouse, activates a software connection module that allows the user to move between documents (i.e., within the same website or to other websites).

Paid advertising on the Web is a major source of revenue for many online businesses. For example, search engines and web content providers sell advertising in various forms. It is not uncommon that a Web-based business will provide free content to individual users and earn most or all of their revenue selling advertising.

The most common forms of Web advertising are probably the banner and the pop up. Banners are typically seen on the same page as the web content that the user is viewing. By contrast, a pop up ad appears when a web site opens a new browser window that remains visible until the user closes the window. Unlike static banner advertisements, pop ups are difficult to ignore and have been found to have a higher click rate. Accordingly, web sites are able to earn greater revenue using pop up ads. However, many users become annoyed by pop up ads and install pop up blocking programs that have been shown to be effective against certain types of pop ups.

However, advertisers and web content providers still desire newer and better forms of advertising over the Web. It would be desirable to have a method for advertising that would gain more attention. Preferably, the method would also be less annoying to users than existing methods of Web advertising.

### SUMMARY OF THE INVENTION

The present invention provides a method of on-line advertising through a computer, personal digital assistant, mobile phone, or other Web-enabled device having an installed Web browser application. The method comprises downloading Web page content and at least one advertisement into a Web browser application capable of opening a window having a client area. The Web page content is then displayed in the client area of the Web browser window in an apparently conventional manner and user interaction with the Web browser window is monitored. As a result of the Web browser window experiencing an event selected from the group consisting of becoming deactivated, becoming idle and combinations thereof, at least a portion of the content displayed in the client area of the Web browser window is substituted with the at least one advertisement. Then, as a result of the Web browser window experiencing an event selected from the group consisting of becoming activated, receiving user input, and combinations thereof, the at least one advertisement is removed in order to display the Web page content in the client area of the Web browser window. The Web browser window can become deactivated through activation of a second window, which may run another instance of the Web browser or a different application program.

Optionally, the at least one advertisement may be downloaded along with the Web content or downloaded earlier or later than the Web content, such as at the time the Web browser window becomes deactivated or idle. When the at least one advertisement is available before it is needed, the at least one advertisement may be preloaded prior to the Web browser window experiencing an event selected from the group consisting of becoming deactivated, becoming idle and combinations thereof.

In one embodiment of the method, the at least one advertisement includes a plurality of advertisements. Accordingly, the method may further comprise substituting at least one different advertisement from the plurality of advertisements each time the Web browser window experiences an event selected from the group consisting of becoming deactivated, becoming idle, and combinations thereof. Furthermore, a different advertisement may be substituted on a periodic basis during a continuous period of a condition selected from the group consisting of deactivated, idle, and combinations thereof.

In another embodiment, the method includes a delay period after the Web browser window experiencing an event selected from the group consisting of becoming activated, receiving user input, and combinations thereof, before removing the at least one advertisement. Optionally, the at least one advertisement may include at least one hyperlink that is executable during the delay period.

In yet another embodiment, the invention provides a computer program product comprising a computer useable medium having computer usable code for online advertising on a computer system. The computer program product comprises computer useable program code for displaying the Web page content in the client area of the Web browser window, monitoring user interaction with the Web browser window, substituting at least a portion of the content displayed in the client area of the Web browser window with at least one advertisement as a result of the Web browser window experiencing an event selected from the group consisting of becoming deactivated, becoming idle and combinations thereof, and removing the at least one advertisement to display the content in the client area of the Web browser window as a result of the Web browser window experiencing an event selected from the group consisting of becoming activated, receiving user input, and combinations thereof. Optionally, the computer program product may provide computer useable program code for carrying out other steps of the various methods of the present invention.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of a communication network.

FIG. 2 is a schematic diagram of a computer system that is suitable for operating a Web browser and displaying advertisements in accordance with the present invention

FIGS. 3-6 are diagrams of a computer screen or visual display of another Web-enabled device illustrating an embodiment of the invention.

FIGS. 7A-B are a flow chart of an exemplary method for Web advertising.

### DETAILED DESCRIPTION OF PREFERRED EMBODIMENTS

The present invention provides systems, computer program products and methods that are useful for online advertising through a computer, personal digital assistant, mobile phone, or other Web-enabled device having an installed Web browser application. The method displays an advertisement in a Web browser window when the window becomes deactivated or idle for a period of time. Accordingly, a user returning to their computer after minutes away or reactivating the Web browser window after working in another window will first see the advertisement. Preferably, the advertisement will cover or replace the Web content that had been previously loaded and displayed in the Web browser window. However, it is desirable for the Web content to remain loaded in memory so that the Web content may be “flipped” or quickly displayed after reactivating the window or detecting user interaction with the window. However, the advertisement preferably remains for a brief delay period after either reactivation or detection of user interaction in order to enhance advertising effectiveness and provide the user with a brief opportunity to read the advertisement or click on a hyperlink for more information. In a further option, the advertisement might include a specific rollover area that would allow the user to intentionally retain the advertisement regardless of exceeding the brief delay period, so that an interesting advertisement could be read and considered more carefully. After the delay period and removing the mouse from the rollover area, it is preferred that the Web content automatically return to display in the client area of the Web browser window.

The method of the invention may be performed or executing in accordance with instructions provide by the hyper text markup language (HTML) that provides the Web page content, along with an embedded program. The embedded program may be written in any suitable language, including, without limitation, a suitable scripting language like JavaScript or a program such as a Java applet. The embedded program may interact with an application programming interface (API) of the windows operating system or the Web browser application in order to display the advertisement or Web content and to detect activation/deactivation of the browser window and/or user input directed to the browser window.

The Web page content and at least one advertisement are downloaded to a user's Web-enabled device from a Web server into a Web browser application capable of opening a window having a client area. The Web page content is selected by the user by entering a uniform resource locater (URL) into the address bar of the Web browser. The Web content is then displayed in the client area of the Web browser window in an apparently conventional manner and user interaction with the Web browser window is monitored.

The embedded program is loaded into memory and implements the method of the present invention. As a result of the Web browser window experiencing an event selected from the group consisting of becoming deactivated, becoming idle and combinations thereof, at least a portion of the content displayed in the client area of the Web browser window is substituted with the at least one advertisement. Most preferably, the at least one advertisement fills the Web browser window at the present size of the client area of the window. The advertisement is preferably maintained within the window and remains until the window is activated after becoming deactivated or detects user interaction with the window after exceeding an idle timeout period.

One embodiment of the invention includes the use of a plurality of advertisements. These advertisements may be downloaded along with the Web content or at one or more different points in time. The advertisements may be displayed simultaneously, sequentially or in some dynamic display, such as scrolling advertisements or a slideshow. It is possible for sequential advertisements to be used in a manner in which only one advertisement is used in each deactivation/idling cycle of the Web browser window or in a manner where two or more advertisements are sequentially displayed one after the other until the activation/interaction of the Web browser window. Optionally, window activation or user interaction with the window can be setup to cause the browser to reload or refresh the current page of the Web content, and maintain the display of the advertisement until the reloading is complete.

Then, after the Web browser window experiences an event selected from the group consisting of becoming activated, receiving user input, and combinations thereof, the at least one advertisement is removed in order to display the Web page content in the client area of the Web browser window. The Web browser window can become deactivated through activation of a second window, which may run another instance of the Web browser or a different application program.

Optionally, the at least one advertisement may be downloaded along with the Web content or downloaded earlier or later, such as at the time the Web browser window becomes deactivated or idle. When the at least one advertisement is available before it is needed, the at least one advertisement may be preloaded into memory prior to the Web browser window experiencing an event selected from the group consisting of becoming deactivated, becoming idle and combinations thereof.

In one embodiment of the method, the at least one advertisement includes a plurality of advertisements. Accordingly, the method may further comprise substituting at least one different advertisement from the plurality of advertisements each time the Web browser window experiences an event selected from the group consisting of becoming deactivated, becoming idle, and combinations thereof.

In another embodiment, the method includes a delay period after the Web browser window experiences an event selected from the group consisting of becoming activated, receiving user input, and combinations thereof, before removing the at least one advertisement. Optionally, the at least one advertisement may include at least one hyperlink that is executable during the delay period.

While the methods and apparatus that are included in the field of data processing comprise a wide variety of programs and programming languages, those having ordinary skill in the art will appreciate that the present invention may be implemented without limitation to a particular program or programming language, a particular application program or a particular system.

In particular embodiments of the present invention, the Web content or the Web browser application interacts or communicates with an application program interface (API) of the windows operating system. For example, an API is a set of routines, protocols and/or tools associated with a known operating system and/or application program. The API provides an interface with the operating system and/or application program for which it is associated. Therefore, an appropriate API may be selected that identifies the size and location of various application windows, including the Web browser window. A specific API may then be utilized to determine whether the Web browser window is activated or deactivated, and the level of user interaction with the Web browser window.

Specifically, the WINDOWS operating system (WINDOWS is a registered trademark of the Microsoft Corporation, Seattle, Wash.) may send a notification or message whenever a window belonging to a different application than the active window is about to be activated. This message, such as a WM_ACTIVATEAPP message, is sent to the application whose window is being activated and to the application whose window is being deactivated. This is just one example of how the online advertising application program of the present invention might determine that the window is being activated or deactivated.

Similarly, a JAVA applet may be programmed to detect these conditions or receive a windows message regarding window activation, window deactivation, and user interaction with the window. For example, the JAVA command WindowDeactivated can be used to identify when the window has become deactivated and can then take other steps to cause the Web browser window to display an advertising image instead of the Web content. The JAVA command WindowActivated can also be used to identify when the window has become activated and can then take other steps to cause the Web browser window to display the Web content, preferably after a short delay.

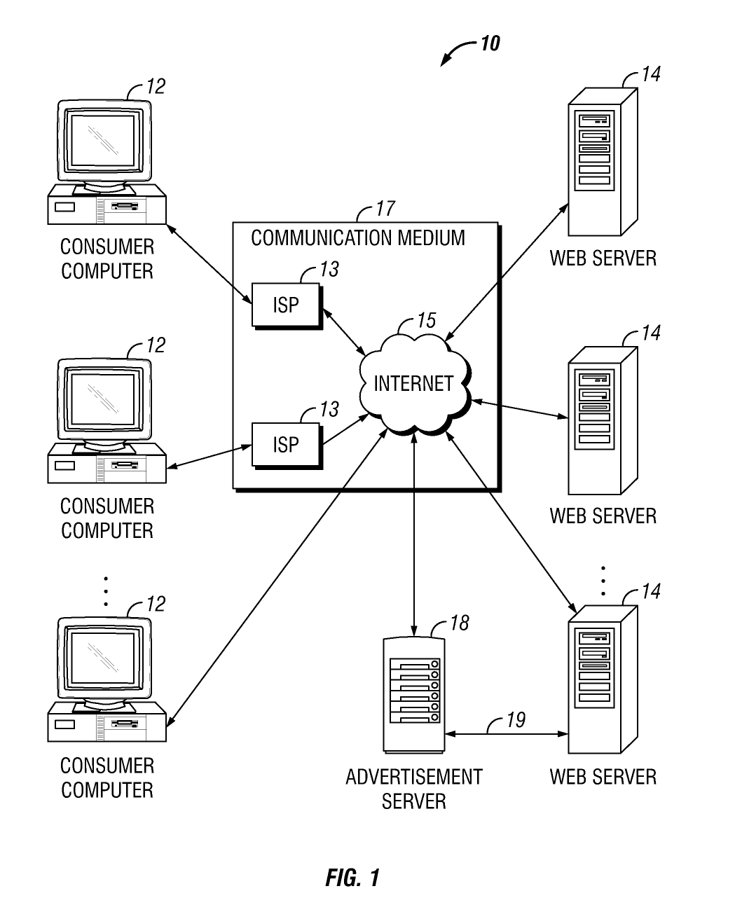

FIG. 1 is a schematic diagram of a system allowing communication between any number of remote computers. The interactive communication system 10 includes at least one consumer computer 12, at least one Web server 14 for providing Web content, and an optional advertisement server 18 which communicate with each other by use of a communication medium 17. In operation, a consumer directs the consumer computer 12 to communicate with the Web Server 14 via the communication medium 17. Typically, the consumer computer will obtain access to the Internet 15 through an Internet Service Provider (ISP) 13. As previously stated, the consumer device may be any Web-enable device and is not limited to a general purpose computer.

Once the consumer computer 12 establishes a communication link with the Web Server 14, the Web Server 14 transfers Web content to the consumer computer 12. In accordance with one embodiment of the present invention, the Web content contains an embedded advertisement program and advertisement image. However, it should be recognized that the advertisement image may be sent directly from the advertisement server 18 to the consumer computer 12, such as in response to request from the embedded program, or the advertisement image may be sent to the consumer computer 12 from the Web Server 14, which may originate the image or obtain it from a direct link 19 to an advertisement server 18.

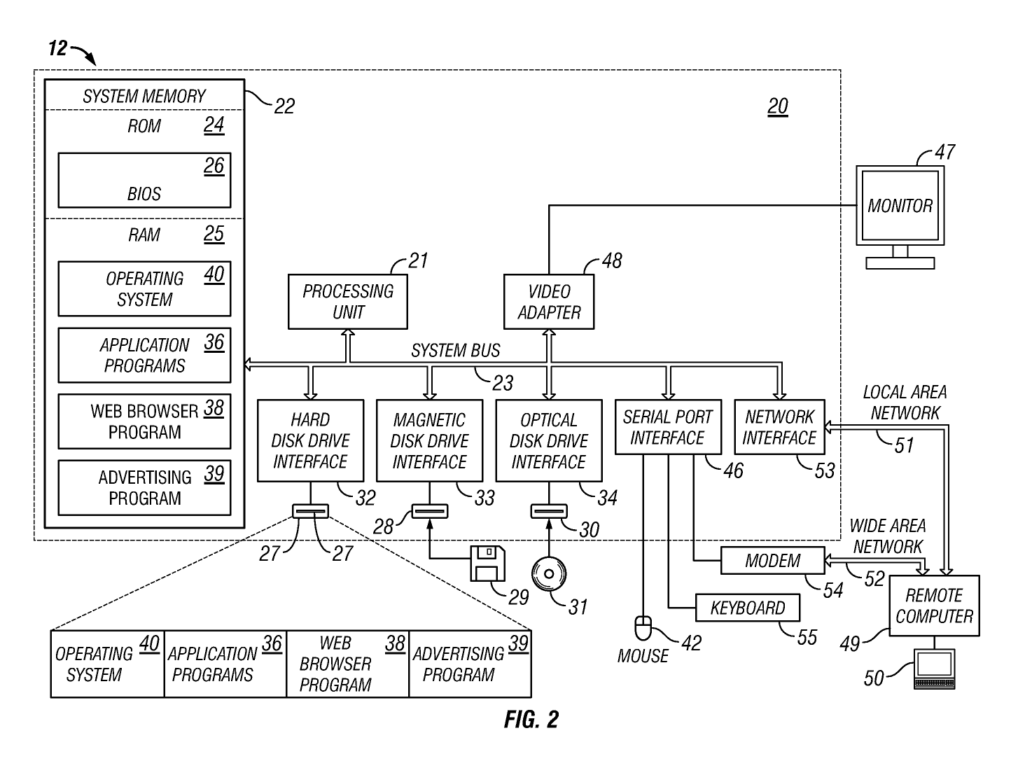

FIG. 2 is a schematic diagram of a system that is suitable for receiving Web content and the advertising program and displaying the advertisement image on a display screen. The system 10 includes a general-purpose computing device in the form of a conventional personal computer 20. Generally, a personal computer 20 includes a processing unit 21, a system memory 22, and a system bus 23 that couples various system components including the system memory 22 to processing unit 21. System bus 23 may be any of several types of bus structures including a memory bus or memory controller, a peripheral bus, and a local bus using any of a variety of bus architectures. The system memory includes a read only memory (ROM) 24 and random access memory (RAM) 25. A basic input/output system (BIOS) 26, containing the basic routines that help to transfer information between elements within personal computer 20, such as during startup, is stored in ROM 24.

The personal computer 20 further includes a hard disk drive 35 for reading from and writing to a hard disk 27, a magnetic disk drive 28 for reading from or writing to a removable magnetic disk 29, and an optical disk drive 30 for reading from or writing to a removable optical disk 31 such as a CD-ROM or other optical media. Hard disk drive 35, magnetic disk drive 28, and optical disk drive 30 are connected to system bus 23 by a hard disk drive interface 32, a magnetic disk drive interface 33, and an optical disk drive interface 34, respectively. Although the exemplary environment described herein employs hard disk 27, removable magnetic disk 29, and removable optical disk 31, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for the personal computer 20. For example, the operating system 40 and application programs 36 may be stored in the RAM 25 and/or hard disk 27 of the personal computer 20.

A user may enter commands and information into personal computer 20 through input devices, such as a keyboard 55 and a pointing device 42. Other input devices (not shown) may include a microphone, joystick, game pad, satellite dish, scanner, or the like. These and other input devices are often connected to processing unit 22 through a serial port interface 46 that is coupled to the system bus 23, but may be connected by other interfaces, such as a parallel port, game port, a universal serial bus (USB), or the like. A display device 47 may also be connected to system bus 23 via an interface, such as a video adapter 48. In addition to the monitor, personal computers typically include other peripheral output devices (not shown), such as speakers and printers.

The personal computer 20 may operate in a networked environment using logical connections to one or more remote computers 49. Remote computer 49 may be another personal computer, a server, a client, a router, a network PC, a peer device, a mainframe, a personal digital assistant, an Internet-connected mobile telephone or other common network node. While a remote computer 49 typically includes many or all of the elements described above relative to the personal computer 20, only a memory storage device 50 has been illustrated in the figure. The logical connections depicted in the figure include a local area network (LAN) 51 and a wide area network (WAN) 52. Such networking environments are commonplace in offices, enterprise-wide computer networks, intranets, and the Internet.

When used in a LAN networking environment, the personal computer 20 is often connected to the local area network 51 through a network interface or adapter 53. When used in a WAN networking environment, the personal computer 20 typically includes a modem 54 or other means for establishing high-speed communications over WAN 52, such as the Internet. Modem 54, which may be internal or external, which is connected to system bus 23 via serial port interface 46. In a networked environment, program modules depicted relative to personal computer 20, or portions thereof, may be stored in the remote memory storage device 50. It will be appreciated that the network connections shown are exemplary and other means of establishing a communications link between the computers may be used.

A number of program modules may be stored on hard disk 27, magnetic disk 29, optical disk 31, ROM 24, or RAM 25, including an operating system 40, application programs 36, a Web browser program 38 and the advertising program 39 associated with the Web content receiving in accordance with the present invention. Program modules include routines, subroutines, programs, objects, components, data structures, and the like, which perform particular tasks or implement particular abstract data types. Aspects of the present invention may be implemented in the form of a Web browser program 38 for receiving Web content including an advertising program 39, where the advertising program will manages and displays advertising images or content in accordance with the invention. The advertising program 39 generally comprises computer-executable instructions for, inter alia, identifying whether the window of a Web browser 38 is deactivated or idle, displaying advertisements in the Web browser window during deactivated or idle periods, and monitoring user interaction with the window.

The example shown in FIG. 2 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

It should be recognized therefore, that embodiments of the present invention may take the form of an entirely hardware embodiment, an entirely software embodiment or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

While inventive embodiments of methods are demonstrated in the following flow charts of the figures that follow, it should be realized that the demonstrated methods are exemplary methods provided by the present invention and may be implemented using computer code and/or a suitable system.

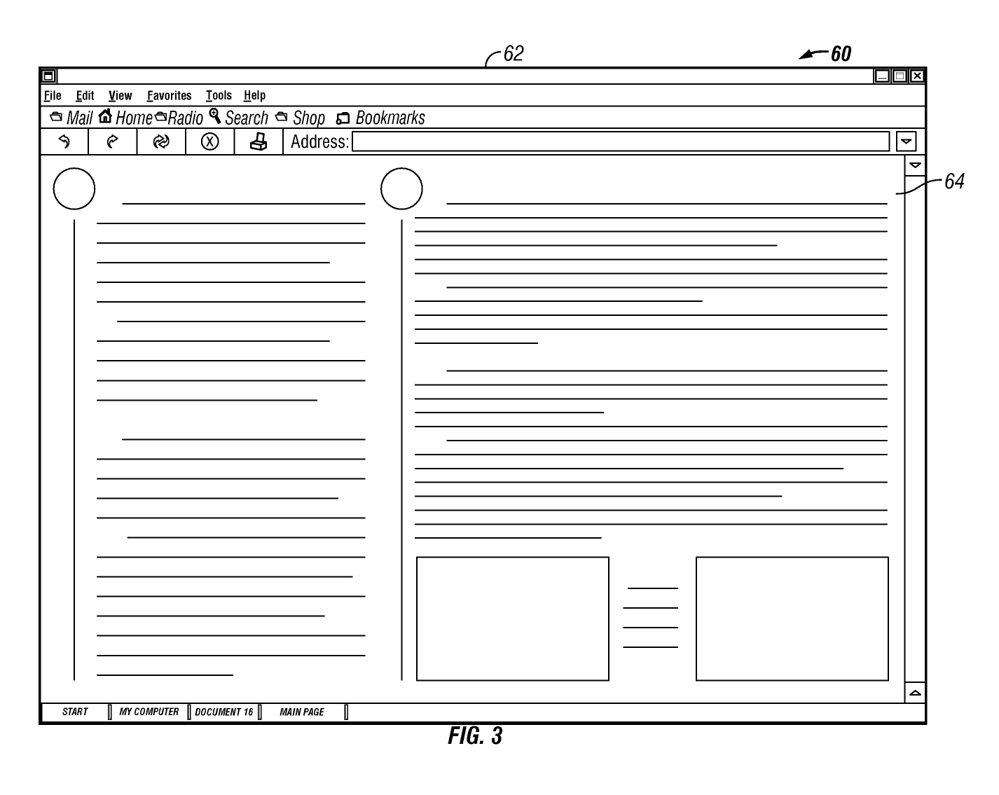

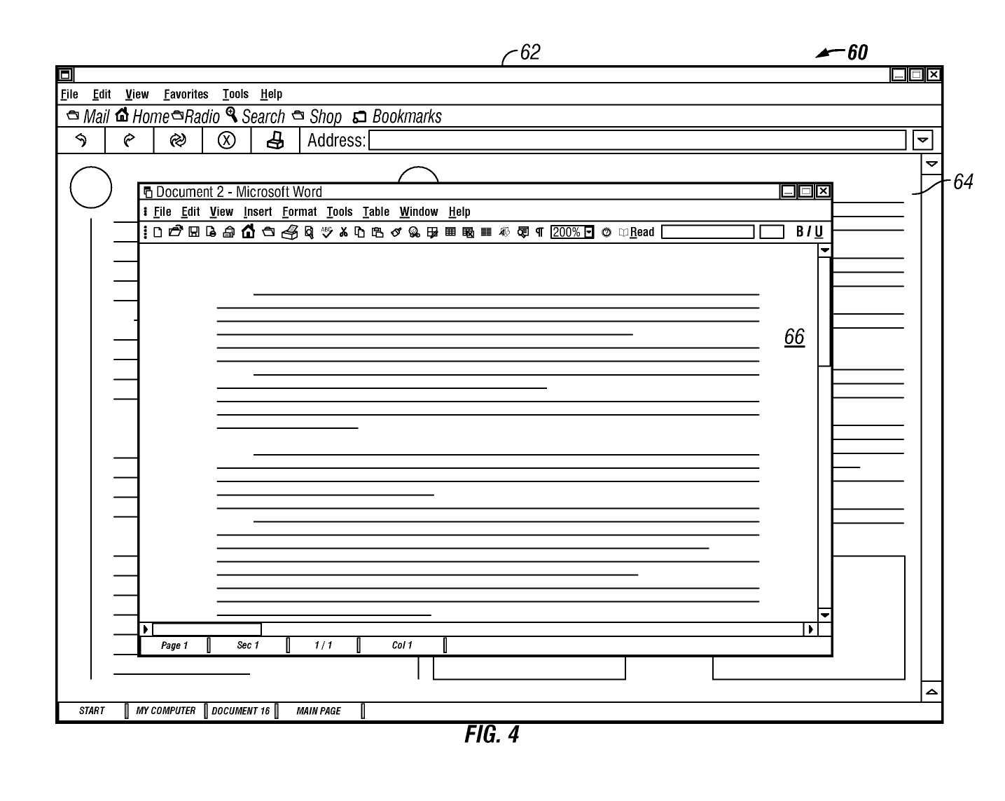

FIGS. 3-6 are diagrams of a computer screen or visual display 60 of another Web-enabled device. This series of Figures illustrates the use of the present invention for displaying an advertisement on a deactivated or idle Web browser window 62. In FIG. 3, the Web browser window 62 has displayed Web content 64 from a Web Server in accordance with the URL entered into the address bar of the browser. In FIG. 4, a second window 66 has been activated in front of the Web browser window 62. As shown, the second window 66 is being controlled by a word processing application program, but the second window 66 could be another instance of a Web-browser or any other application program. However, when the second window 66 becomes activated, such as by clicking a mouse pointer in the word processing screen so that keyboard input is direct to the second window, the Web browser window 62 becomes deactivated. As illustrated, the Web browser window 62 has become deactivated, but the Web content 64 in the client area of the Web browser window 62 has not yet been substituted with an advertising image.

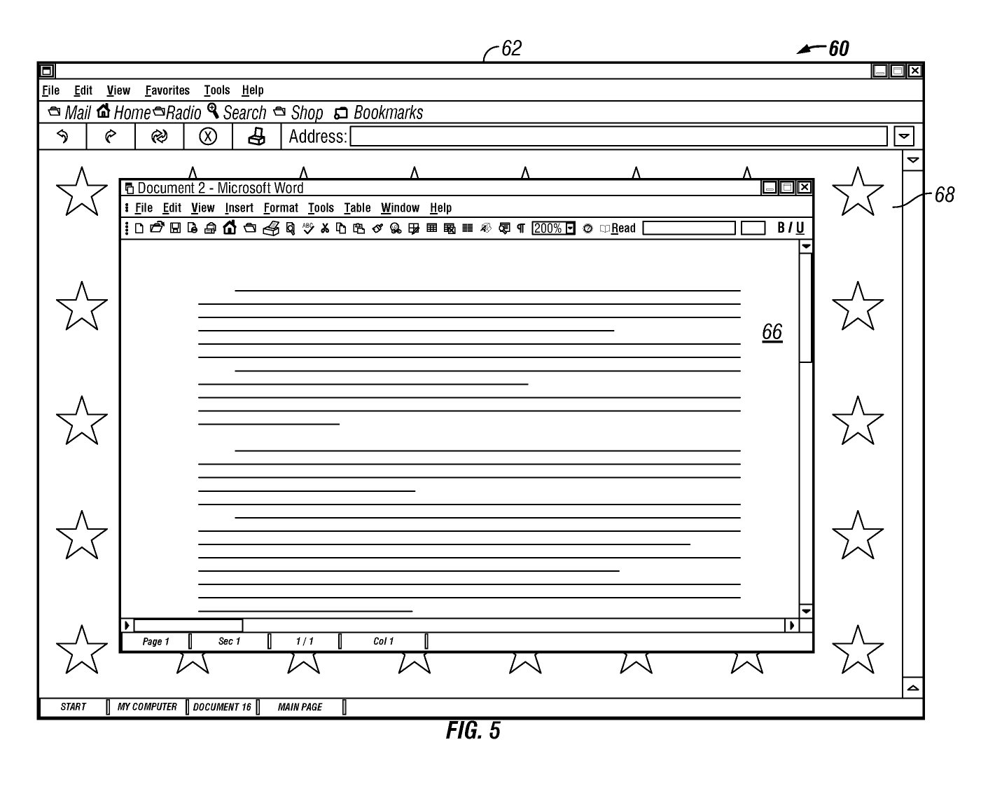

In FIG. 5, the advertising program has determined that the Web browser window 62 is deactivated and taken steps to substitute an advertising image 68 for the Web content 64 (See FIG. 4). As shown, the display of the advertising image 68 covers the entirety of the client area of the window 62. However, it should be recognized that the advertising image could be smaller or the client area could be shared by multiple advertising images, such as one above the other. The advertising image 68 is preferably maintained until after the Web browser window 62 becomes activated or is no longer idle.

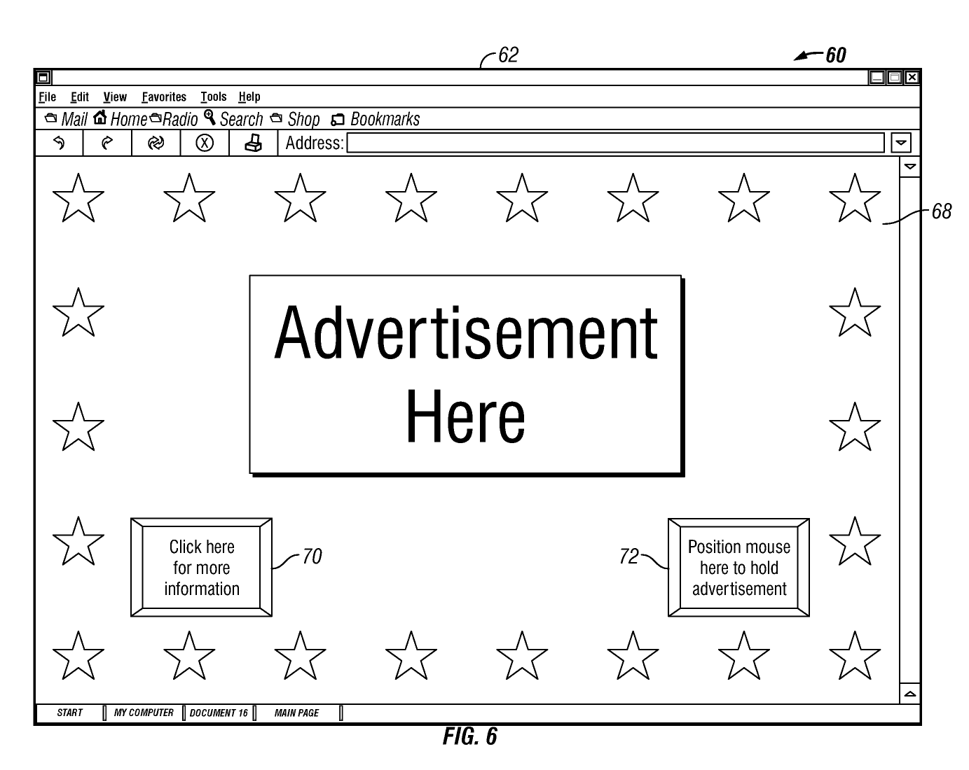

In FIG. 6, the second window 66 has been either minimized, closed, or otherwise replaced as the top window. Any of these actions will activate the Web browser window 62 and reveal the full advertising image 68. Preferably, the advertising image 68 continues to be displayed for a short delay period, such as 1 to 3 seconds, before again displaying the Web content 64 as shown in FIG. 3. While it is also preferred to automatically replace the advertising image with the Web content without requiring any further user interaction than activation of the window or activity within the window, the advertising image 68 in FIG. 6 is provided with two boxes that provide the user with other options. A first box 70, or an image or text, provides a hyperlink to additional information about the advertised product or service. For example, the user may click on the hyperlink in order to redirect the Web browser to Web content from the Web site of the company that sponsored the advertisement 68. A second box 72, or an image or text, may provide a rollover area that can prolong the display of the advertising image so that the user has more time to read, watch or consider the advertising image, which can include pictures, video, text, audio or a combination thereof. For example, the Web browser window 62 may have been activated by clicking with a mouse inside the window 62. However, if the user positions the mouse pointer over the second box 72 before the normal delay period has expired, then the advertising image will be maintained until the mouse pointer has moved out of the second box 72 for a subsequent delay period. The subsequent delay period should provide time for the user to roll the mouse from the second box 72 to the first box 70 in order to request more information.

Furthermore, it should be recognized that although the prior page of Web content 64 extended “below the fold”, meaning that the content could not be seen immediately without scrolling downward, it is preferred that the advertisement remain “above the fold.” The advertising program may resize an advertising image file to fit the window by retrieving the coordinates of the window's client area from the operating system. Furthermore, if the advertising image 68 will be removed after activating the associated Web browser window 62, then even an attempt to scroll the advertising image would lead to removal of the advertising image.

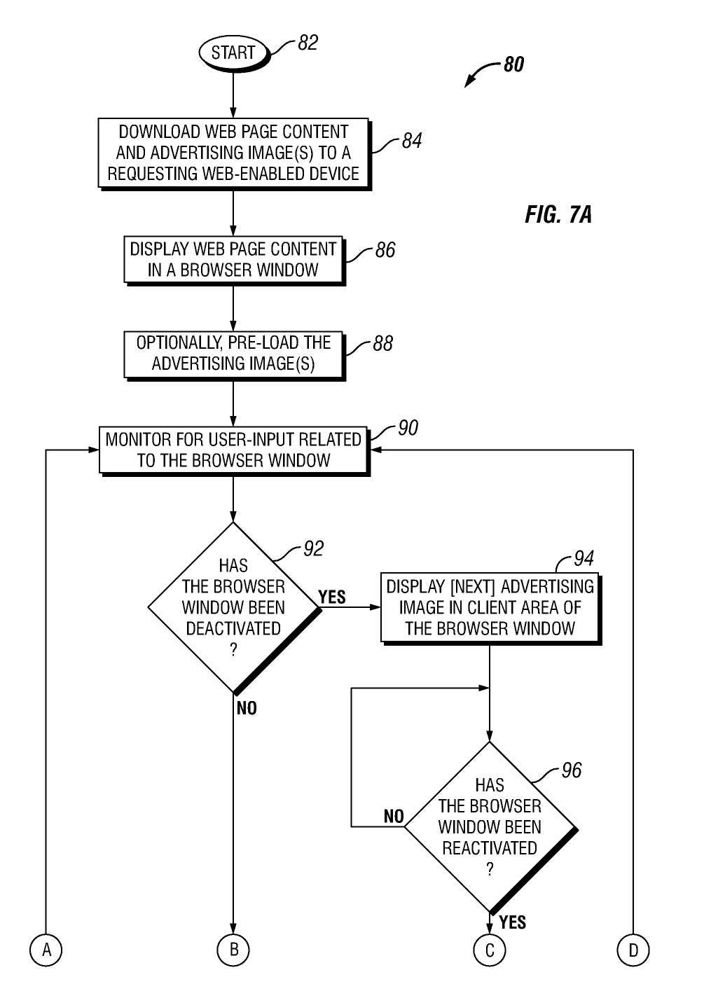

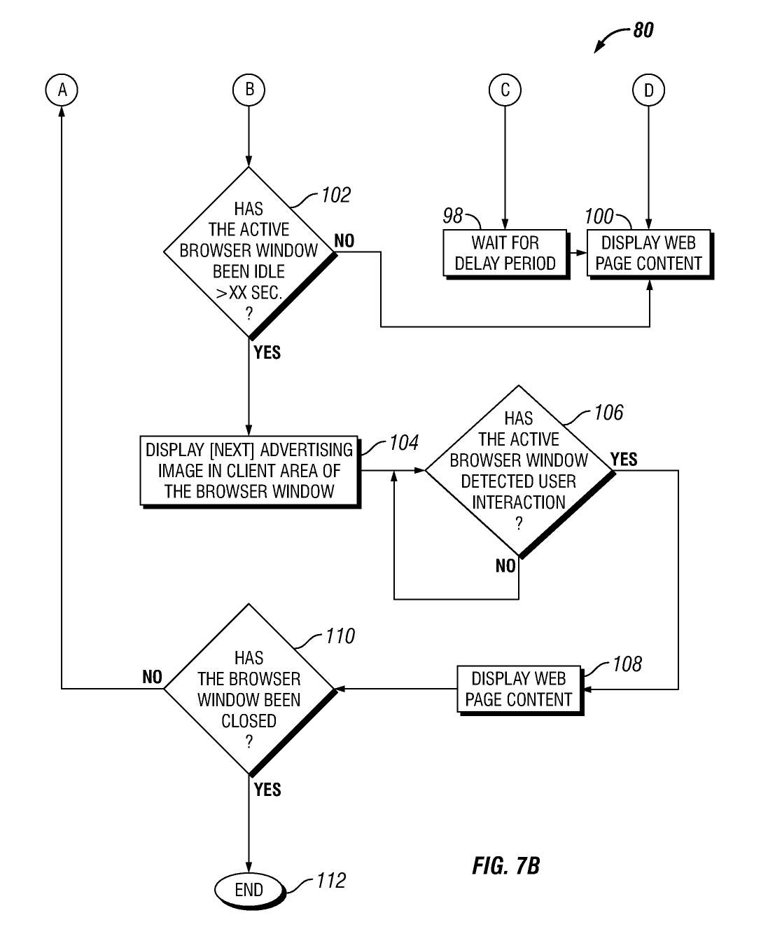

FIGS. 7A-B provide a flow chart of an exemplary method 80 for Web advertising. The method starts in state 82, followed by downloading Web page content and one or more advertising image to a requesting Web-enabled device, in state 84. In state 86, the Web page content is displayed in a Web browser window. Optionally, the one or more advertising image is pre-loaded into memory of the Web-enabled device, in state 88. The method then monitors for user input related to the Web browser window, in state 90.

The method continues at state 92 to determine whether the Web browser window has been deactivated. If the Web browser has been deactivated, then in state 94 an advertising image is displayed in the client area of the Web browser window. This advertising image may be the only image available or it might be the next image in a set of advertising images. After displaying an advertising image, it is determined, in state 96, whether the Web browser window has been reactivated. If the window has not been reactivated, then the advertising image continues to be displayed. However, if the Web browser window has been reactivated, then the method waits for a delay period, in state 98, and displays the Web page content, in state 100, before returning to state 90 to monitor for further user input related to the Web browser window.

If it is determined, in state 92, that the Web browser window has not been deactivated, then it is determined, in state 102, whether the active Web browser window has been idle for greater than an inactivity period, such as a setpoint period of some seconds or minutes. If the window has not been idle for the inactivity period, then the Web page content continues to be displayed in state 100. However, if the window has been idle, then the advertising image is displayed in the client area of the Web browser window in state 104. Next, it is determined whether the active Web browser window has detected user interaction with the window in state 106. If there is not user interaction detected, then the advertising image continues to be displayed. However, after detecting user interaction with the window, the Web page content is displayed in state 108. If state 110 determines that the Web browser window has not been closed, then the method continues back to state 90 to further monitor for user input. However, if the window has been close, the method ends in state 112.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method of on-line advertising, comprising:
downloading Web page content and at least one advertisement into a Web browser application capable of opening a window having a client area;
displaying the Web page content in the client area of the Web browser window;
monitoring user interaction with the Web browser window;
substituting at least a portion of the content displayed in the client area of the Web browser window with the at least one advertisement as a result of the Web browser window experiencing an event selected from the group consisting of becoming deactivated, becoming idle and combinations thereof; and
removing the at least one advertisement to display the content in the client area of the Web browser window as a result of the Web browser window experiencing an event selected from the group consisting of becoming activated, receiving user input, and combinations thereof.

2. The method of claim 1, wherein the Web browser window becomes deactivated through activation of a second window.

3. The method of claim 1, wherein the second window runs another instance of the Web browser.

4. The method of claim 1, wherein the second window runs a different application program.

5. The method of claim 1, further comprising:
including a delay period after the Web browser window experiences an event selected from the group consisting of becoming activated, receiving input, and combinations thereof before removing the at least one advertisement.

6. The method of claim 1, wherein the at least one advertisement includes at least one hyperlink that is executable during the delay period.

7. The method of claim 1, further comprising:
preloading the at least one advertisement prior to the Web browser window experiencing an event selected from the group consisting of becoming deactivated, becoming idle and combinations thereof.

8. The method of claim 1, wherein the at least one advertisement includes a plurality of advertisements, the method further comprising:
substituting at least one different advertisement from the plurality of advertisements each time the Web browser window experiences an event selected from the group consisting of becoming deactivated, becoming idle and combinations thereof.

9. The method of claim 1, wherein the Web browser application is installed on a computer, personal digital assistant, or mobile phone.

10. A computer program product comprising a computer useable medium having computer usable code for online advertising on a computer system, the computer program product comprising:
computer useable program code for displaying the Web page content in the client area of the Web browser window;
computer useable program code for monitoring user interaction with the Web browser window;
computer useable program code for substituting at least a portion of the content displayed in the client area of the Web browser window with at least one advertisement as a result of the Web browser window experiencing an event selected from the group consisting of becoming deactivated, becoming idle and combinations thereof; and
computer useable program code for removing the at least one advertisement to display the content in the client area of the Web browser window as a result of the Web browser window experiencing an event selected from the group consisting of becoming activated, receiving user input, and combinations thereof.

11. The computer program product of claim 10, further comprising:
computer useable program code for including a delay period after the Web browser window experiences an event selected from the group consisting of becoming activated, receiving user input, and combinations thereof before removing the at least one advertisement.

12. The computer program product of claim 11, further comprising:
computer useable program code for including at least one hyperlink in the at least one advertisement, wherein the hyperlink is executable during the delay period.

13. The computer program product of claim 10, further comprising:
computer useable program code for preloading the at least one advertisement prior to the Web browser window experiencing an event selected from the group consisting of becoming deactivated, becoming idle and combinations thereof.

14. The computer program product of claim 10, wherein the at least one advertisement includes a plurality of advertisements, further comprising:
computer useable program code for substituting at least one different advertisement from the plurality of advertisements each time the Web browser window experiences an event selected from the group consisting of becoming deactivated, becoming idle and combinations thereof.
